(19) United States
(12) Patent Application Publication
(10) Pub. No.: US 2018/0043404 A1
(43) Pub. Date: Feb. 15, 2018

(54) Site Remediation System and A Method of Remediating A Site

(71) Applicant: Tetra Tech, Inc., Pasadena, CA (US)

(72) Inventors: Andrew Labbett, Abbotsford (AU); Michael Blackam, Abbotsford (AU); Yik Cheong, Abbotsford (AU)

(21) Appl. No.: 15/558,316

(22) PCT Filed: Mar. 16, 2016
(86) PCT No.: PCT/US16/22623

§ 371 Date: Sep. 14, 2017

(30) Foreign Application Priority Data
Mar. 17, 2015 (AU) 2015900954

(51) Int. Cl. B09C 1/00; E21B 43/08; A62D 3/02; B09C 1/10; B09C 1/06

(52) U.S. Cl. CPC B09C 1/002; B09C 1/10; B09C 1/06; A62D 3/02; E21B 43/084

(57) ABSTRACT

A site remediation system for remediating a site including a liquid recirculation mechanism for taking liquid to be remediated from the site, heating the liquid along the liquid recirculation mechanism, optionally treating the liquid using a bioremediation mechanism, and then returning the liquid to the site at an elevated temperature.

### PRIORITY CLAIM

This PCT application claims priority to Australian provisional application number 2015900954 entitled “A site remediation system and a method of remediating a site” which was filed on Mar. 17, 2015, the entirety of which is incorporated herein by reference.

### TECHNICAL FIELD

This disclosure relates, generally, to the remediation of contaminated sites and, more particularly, to a site remediation system and to a method of remediating a site.

### BACKGROUND

Many remediation technologies, for example, those adopted by the retail petroleum sector to remediate a filling station site, utilize extraction and treatment equipment to effect “aggressive” remediation strategies in order to remediate the site. These strategies result in high energy consumption since a key driver is a need to complete remediation work in an accelerated timeframe while often needing to comply with regulator-enforced clean-up requirements. This reactionary and high energy usage approach tends to ignore the energy impact and greenhouse gas emission associated with remediation.

In addition, at many sites where the bulk of the primary and secondary contaminant sources have been removed, longer timeframes may be required for close out due to the need to treat lower level contamination that may be diffuse or is less amenable to common remediation approaches. The cost and greenhouse gas impact of continuing to operate conventional approaches, such as, for example, pump-and-treat and air-sparging, at these sites can mean that any net improvement to the environment is often outweighed by the environmental impact due to energy usage of the remediation equipment.

Soil and groundwater remediation, although designed to remedy contamination and reduce risks to human health and/or the environment, also has the potential to cause environmental, economic and social impacts. If poorly selected, designed and implemented, remediation technologies and activities may cause greater impact than the contamination that they seek to address. The best solution, therefore, is remediation that minimizes unacceptable risks in a safe and timely manner while maximizing the overall environmental, social and economic benefits of the remediation work.

### SUMMARY

In a first aspect, there is provided a site remediation system which includes

a liquid recirculation mechanism powered by a low energy power source, the liquid recirculation mechanism comprising
a liquid extraction component for extracting liquid to be remediated from a substrate at the site; and
a heater component for heating the extracted liquid, in turn, to increase a subsurface temperature of the substrate upon re-injection of the heated liquid into the substrate; and

a bioremediation mechanism arranged downstream of the heater component of the liquid recirculation mechanism, the bioremediation mechanism comprising a liquid treatment unit for treating the heated liquid prior to re-injection of the liquid into the substrate to effect enhanced substrate bioremediation.

In this specification the term “low energy power source” is to be understood, unless the context clearly indicates otherwise, as a source which results in minimal greenhouse gas emissions. A non-exhaustive list of low energy power sources includes a battery powered energy source, a solar powered energy source, a wind powered energy source, or the like. Further, the term “enhanced bioremediation” is to be understood, unless the context clearly indicates otherwise, as a term used to describe the process of increasing the activity of indigenous contaminant utilising microbes to reduce contaminant mass.

Thus, the basis of the site remediation system comprises an active component, the liquid recirculation mechanism, and a passive component, the enhanced substrate bioremediation.

The liquid recirculation mechanism may be configured to extract contaminated liquid from, or downgradient of a fringe of a plume, and to re-inject the heated, treated liquid into, or upgradient of, a source zone of the plume.

The liquid extraction component may comprise at least one extraction pump. The at least one extraction pump may be a solar powered pump.

The heater component may comprise at least one solar collector. In an embodiment, the heater component may comprise an array of solar collectors.

The heater component may be configured to heat the liquid to a temperature in a range of about 20° C.-50° C. More particularly, the heater component may be configured to heat the liquid to a temperature of between about 5° C.-15° C. greater than the subsurface temperature of the substrate.

The bioremediation mechanism may comprise at least one entrainment device for at least one of oxygenating the liquid, by entraining air in the liquid, and entraining nutrients in the liquid prior to re-injection of the liquid into the substrate. The at least one entrainment device may comprise a venturi (also referred to as an eductor). In an embodiment, the system may comprise a plurality of venturis arranged in parallel. The number of venturis employed will be dependent on the capacity of the system.

The entrainment device may be configured to entrain both air to oxygenate the liquid and nutrients for enhancing bioremediation effected by subsurface microbes in the substrate.

The system may include a passive media filtration device (granular activated carbon) arranged upstream of the bioremediation mechanism, the filtration device removing contaminants from the heated liquid prior to treating the liquid in the bioremediation mechanism. In certain applications, for example, in sandy substrates, the substrate itself may serve as an infiltration gallery for effecting distribution of the heated, treated liquid upon re-injection into the substrate. In other applications, for example, in more rocky substrates, the system may include an infiltration gallery located within the source zone of the plume for distributing the re-injected treated liquid in the substrate.

The system may be mounted on a displacement mechanism for ease of placement at the site. In an embodiment, the displacement mechanism may comprise skids. In another embodiment, the system may, in use, be mounted in an elevated position, for example, a roof, to reduce space requirements.

In a second aspect, there is provided a method of remediating a site, the method including

extracting liquid to be remediated from a substrate at the site using a low energy power source;

heating the extracted liquid prior to re-injecting the liquid into the substrate to increase a subsurface temperature of the substrate upon re-injection of the heated liquid into the substrate; and

treating the heated liquid prior to re-injection of the liquid into the substrate to effect enhanced substrate bioremediation.

The method may include extracting liquid from, or downgradient of a fringe of, a plume and re-injecting the heated, treated liquid into, or upgradient of, a source zone of the plume.

The method may include extracting the liquid using at least one extraction pump, the, or each, extraction pump being a solar powered pump.

The method may include heating the liquid using at least one solar collector. In an embodiment, the method may include heating the liquid using an array of solar collectors.

The method may include heating the liquid to a temperature in a range of about 20° C.-50° C. More particularly, the method may include heating the liquid to a temperature of between about 5° C.-10° C. greater than the subsurface temperature of the substrate.

The method may include treating the liquid prior to re-injection into the substrate by at least one of oxygenating the liquid, by entraining air in the liquid, and entraining nutrients in the liquid prior to re-injection of the liquid into the substrate.

The method may include entraining material in the liquid using at least one venturi. The method may include entraining both air to oxygenate the liquid and nutrients for enhancing bioremediation effected by subsurface microbes in the substrate.

The method may include filtering the heated liquid prior to treating the liquid to remove contaminants.

The method may include distributing the re-injected, treated liquid in the substrate using an infiltration gallery or infiltration wells at, or upgradient of, the source zone of the plume.

### BRIEF DESCRIPTION OF DRAWINGS

Embodiments of the disclosure are now described by way of example with reference to the accompanying drawings in which:

FIG. 1 shows a schematic representation of a prototype of an embodiment of a site remediation system;

FIG. 2 shows a schematic representation of another embodiment of the site remediation system; and

FIG. 3 shows a schematic representation of a further embodiment of the site remediation system.

### DETAILED DESCRIPTION OF EXEMPLARY EMBODIMENTS

In the drawings, reference numeral 10 generally designates an embodiment of a site remediation system. The system 10 includes a liquid recirculation mechanism 12 powered by a low energy power source which, in the illustrated embodiment, is in the form of one or more solar panels 14.

It will be appreciated that, in other embodiments, the low energy power source could, instead, be any other power source having minimal greenhouse gas emissions such as, for example, a wind powered energy source, a battery powered energy source, or the like.

The liquid recirculation mechanism 12 further comprises a liquid extraction component in the form of at least one solar powered pump 16. The liquid extraction component is mounted within a pumping well 18 formed in a substrate 20 at a site 22 to be remediated. More particularly, the pumping well 18 is arranged at a downgradient fringe of a plume of the site 22.

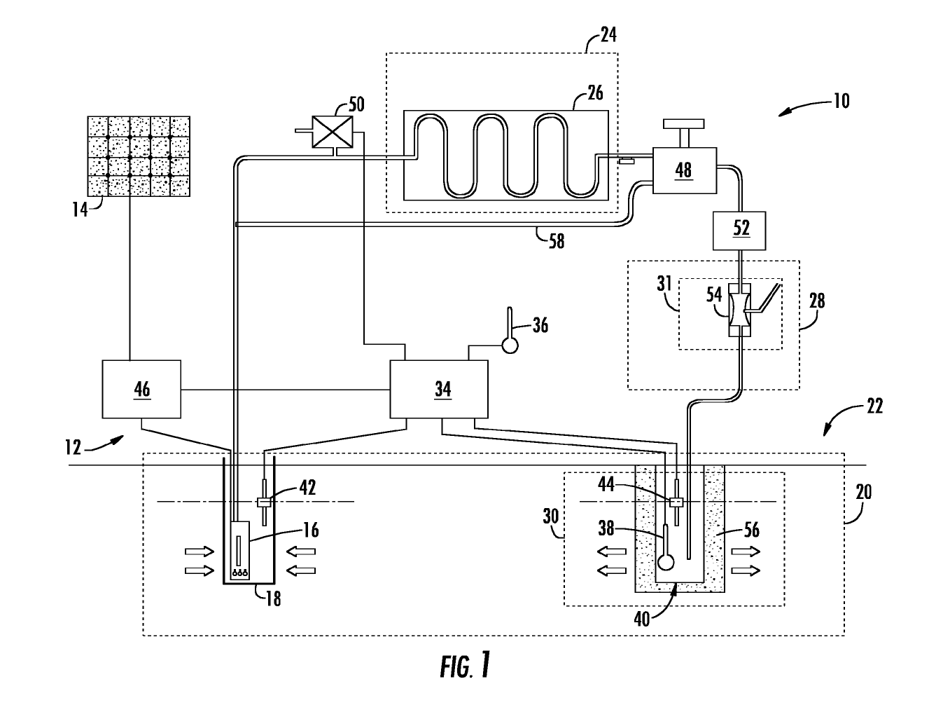

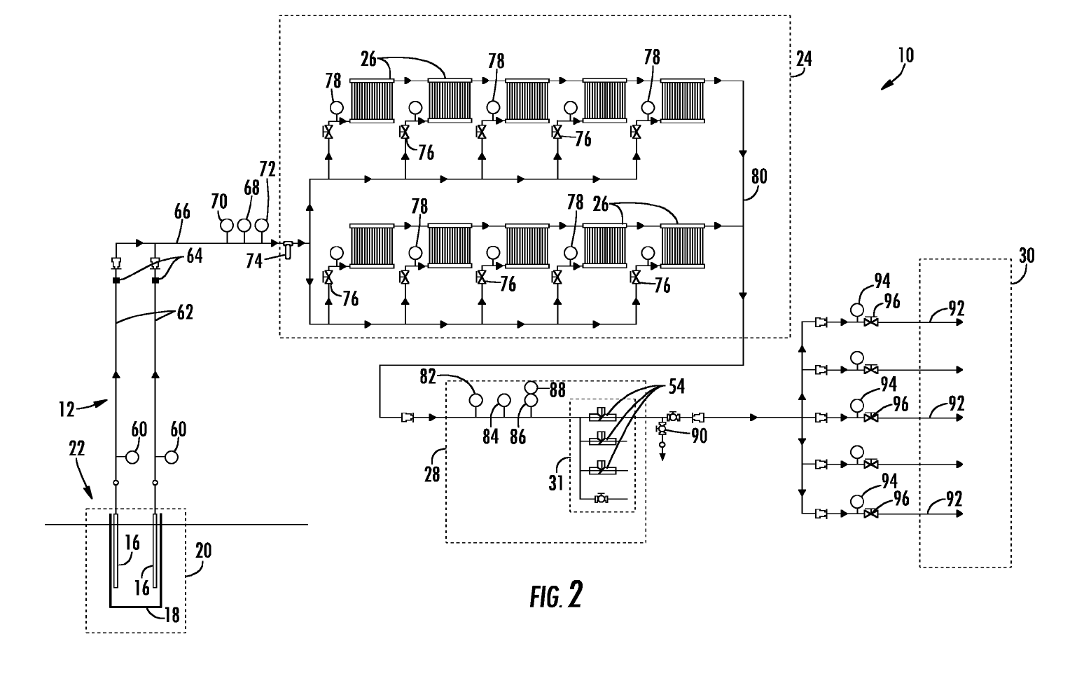

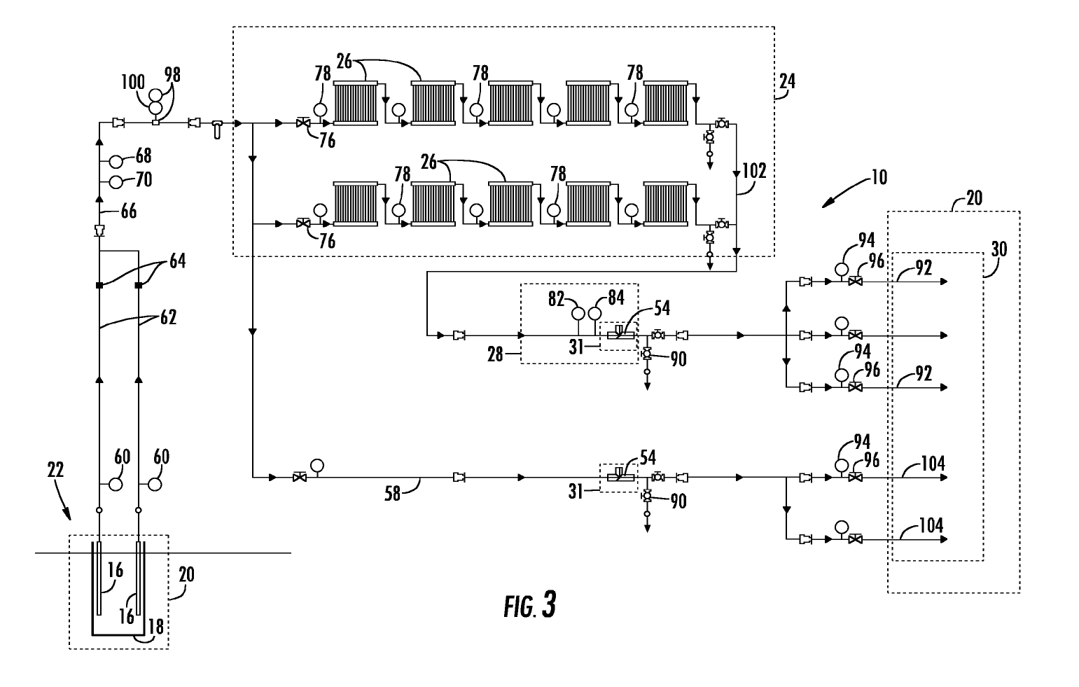

The liquid recirculation mechanism 12 further includes a heater component 24 for heating the extracted liquid, in turn, to increase a sub-surface temperature of the substrate 20 upon re-injection of the heated liquid into the substrate. As illustrated more clearly in FIGS. 2 and 3 of the drawings, the heater component 24 comprises a plurality of solar collectors 26, one of which is shown, schematically, in FIG. 1 of the drawings.

The system 10 includes a bioremediation mechanism 28 arranged downstream of the heater component 24 of the liquid recirculation mechanism 12. The bioremediation mechanism 28 includes a liquid treatment unit 31 for treating the heated liquid prior to re-injection of the heated liquid into the substrate 20 to effect enhanced substrate bioremediation.

The heated liquid is re-injected into the substrate at, or upgradient of, a source zone 30 of the plume in the substrate 20 of the site 22.

In an embodiment, the system 10 includes a system controller 34 which monitors and controls operation of the liquid recirculation mechanism 12 and the bioremediation mechanism 28. The system controller has a thermometer 36 connected to it, the thermometer 36 monitoring ambient temperature. In addition, a second thermometer 38 is arranged in a recharge trench 40 at, or upgradient of, the source zone 30 of the plume for monitoring the temperature of the re-injected liquid.

Level control switches 42 and 44 are mounted in the pumping well 18 and recharge trench 40, respectively, for controlling the level of liquid in each of the pumping well 18 and the recharge trench 40. The level control switches 42 and 44 are connected to the system controller 34.

A solar pump controller 46 is interposed between the solar panels 14 and the pumps 16 for controlling operation of the pumps 16 under control of the system controller 34.

The system 10 further includes a thermostatic mixer, or mixing valve, 48 arranged downstream of the heater component 24. The thermostatic mixer 48 is configured to mix heated and unheated liquid, in appropriate circumstances, to obtain the desired temperature of the liquid to be re-injected into the substrate 20.

If necessary, where ambient temperatures can drop to freezing levels, the system 10 includes a drain venting valve 50. The drain venting valve 50 is connected to the system controller 34 and is opened under control of the system controller 34 to drain the system 10 of liquid when the ambient temperature drops below a predetermined threshold, e.g. freezing. It will be appreciated that in regions not susceptible to very low temperatures, the drain venting valve 50 can be omitted.

The system 10 also includes an optional filtration device 52 arranged intermediate the heater component 24 and the bioremediation mechanism 28. The filtration device 52 is, preferably, a passive media filtration device, such as a granular activated carbon filter, for removing contaminants from the heated liquid prior to treating the liquid in the bioremediation mechanism 28.

The solar pumps 16 are selected to pump at a rate of between about 2000 L and 40,000 L per day, for example, about 5000 L per day. It will be appreciated that the actual pumping rate will be dependent on the capacity of the system 10 and the desired remediation rate, factors which are, in turn, influenced by the size of a contaminant plume and the hydraulic properties of the substrate. A suitable pump for use with the system 10 is a Grundfos pump available from Solarpumps.com.au, a division of Irrigation Warehouse Group of Glen Innes, New South Wales Australia.

The Grundfos pump range includes pumps which can pump at a rate of up to 14,500 L per day at a head of 10 m. The system 10 employs at least two such pumps 16 with the associated number of solar panels 14 for the pumps 16. Depending on the capacity of the pumps 16, each pump 16 has at least two or three solar panels 14 associated with it.

The system 10 is configured to heat the water to a temperature in the range of about 20° C. to 60° C., preferably, about 30° C. Other suitable ranges include 20° C. to 30° C., 30° C. to 40° C., 40° C. to 50° C. and 50° C. to 60° C. In general, it is desired to increase the temperature of the substrate to a more optimal range for bioremediation, in particular, where biodegradation can occur. This optimal range is typically between about 25° C. and about 35° C.

To achieve the desired temperature range, the heater component makes use of a plurality of solar collectors 26. In an embodiment of the system 10, the applicant has found that the use of ten solar collectors 26 for heating the liquid provides the necessary heating capacity to achieve the desired range of sub-surface temperatures in the substrate 20. For example, where ambient temperatures are in the low 20s, using ten solar collectors 26 as the heater component 24 of the system 10 results in an increase in temperature of the liquid of more than 7° C.

As indicated above, the increase in sub-surface temperature of the substrate 20 enhances bio-degradation effected by microbes present in the substrate 20, which reduce contaminant mass more efficiently as a result of the increase in sub-surface temperatures.

The liquid treatment unit 31 is in the form of at least one entrainment device, or venturi, 54. In an embodiment, the liquid treatment unit 31 employs a plurality of venturis 54 arranged in parallel as shown in FIG. 2 of the drawings. The venturis 54 effect oxygenation of the heated liquid by entraining air in the liquid. This enhances aerobic bio-degradation by the microbes in the substrate 20. In addition, other nutrients for the microbes are also entrained in the liquid by the venturis 54.

The contamination of the site 22 is, typically, due to hydrocarbons. To effect bioremediation of such a site, air is entrained in the liquid by the venturis 54 in a ratio sufficient to cause saturation of the liquid. Typically, air is entrained in a ratio of about 3 to 4 parts oxygen to one part hydrocarbon. Further, the nutrients used depend on the hydrocarbons to be treated. Nutrients are entrained by the liquid treatment unit 31 in a ratio of approximately 100 parts hydrocarbon to 10 parts nitrogen to 1 to 2 parts phosphorus.

In some areas, the substrate 20 may comprise sandy materials which can act as an infiltration gallery for effecting distribution of the heated, treated liquid upon re-injection into the substrate 20. In other applications, the substrate 20 may consist of materials less amenable to functioning as the infiltration gallery. For example, the substrate 20 may be of a rocky material. In such a case, the system 10 includes an infiltration gallery 56 surrounding the recharge trench 40 or an array of infiltration wells.

FIGS. 2 and 3 show further embodiments of the system 10. With reference to FIG. 1 of the drawings, like reference numerals refer to like parts unless otherwise specified.

In FIG. 2 of the drawings, each pump 16 has a pressure gauge 60 associated with it mounted in a conduit 62 leading from the pump. A non-return valve 64 is mounted in each conduit 62. Downstream of the valves 64, the conduits 62 are connected together in a feed conduit 66 via which the extracted liquid is fed into the heater component 24. A thermometer 68 is mounted in the feed conduit 66 together with a temperature transducer 70 for feeding data back to the system controller 34 (not shown in this embodiment), a pressure gauge 72 and a filter 74.

The liquid to be heated is pumped via the non-return valves 64 into the solar collectors 26 of the heater component 24 through valves 76. Each solar collector 26 has a pressure gauge 78 associated with it. It is to be noted that the solar collectors 24 are arranged in two banks of parallel connected solar collectors. In this embodiment, the liquid to be heated is pumped into the solar collectors 26 of each bank in parallel.

Heated liquid output from the heater component 24 is fed via a conduit 80 to the bioremediation mechanism 28 which, in this embodiment, comprises three venturis 54 arranged in parallel to provide the required dosing to the liquid. A thermometer 82 is mounted in the conduit 80 together with a temperature transducer 84, a flow rate transducer 86 and a flow meter 88.

A tap-off valve 90 is arranged downstream of the bioremediation mechanism 28 to provide a flow test sampling point.

Treated liquid output from the bioremediation mechanism 28 is injected into, or upgradient of, the source zone 30 via a plurality of parallel conduits 92 to distribute the treated liquid in the substrate 20.

A pressure gauge 94 and a control valve 96 are mounted in each conduit 92.

FIG. 3 shows a further embodiment of the system 10. In this embodiment, as in the case of the embodiment shown in FIG. 1 of the drawings, part of the extracted liquid remains unheated and is tapped off, upstream of the heater component 24, by the conduit 58. In this embodiment, an entrainment unit 31 is arranged in the conduit 58 for treating the liquid by dosing it with air and nutrients. It is therefore to be noted that the thermostatic mixer 48 is omitted.

Further, the system 10 includes a flow meter 98 for measuring the flow rate of the extracted liquid and a flow transducer 100 for feeding data back to the system controller 34 (not shown in this embodiment) arranged upstream of the heater component.

Unlike the embodiment of FIG. 2, where the extracted liquid is fed separately into each solar collector, in the embodiment of FIG. 3, the extracted liquid is split to be fed into the upstream solar collectors of each bank of solar collectors 24. The liquid then flows serially through the solar collectors of each bank before being re-combined in an outlet conduit 102.

In addition, a portion of the extracted liquid is, as described above, fed via the conduit 58 and a further venturi 54 of the bioremediation mechanism 28, where the unheated liquid undergoes dosing, back into the source zone 30 via conduits 104.

Due to the serial heating of the extracted liquid as it passes through the banks of solar collectors 24, greater heating of the liquid occurs. Thus, this embodiment is intended for use where a higher temperature gain than that obtainable with the embodiment of FIG. 2 is required but at a lower flow rate.

To improve the versatility of the system 10, the system 10 may be mounted on a displacement mechanism (not shown), such as skids, for ease of placement at the site 22. Instead, the system 10 could be mounted in an elevated position, for example, a roof, to reduce space requirements.

In use, the system 10 is intended for use at sites 22 where the bulk of primary and secondary contaminant sources has already been removed with the system 10 being used for further reducing residual contamination in a cost-effective, environmentally friendly manner.

Thus, liquid in the form of groundwater to be treated is extracted from the substrate 20 via the solar pumps 16 located in the pumping well 18. The pumps 16 receive power from the solar panels 14 via the solar pump controller 46 under the control of the system controller 34.

The extracted groundwater is pumped into the solar collectors 26 of the heater component 24. The solar collectors 26 heat the extracted groundwater to a temperature which, after re-injection into the substrate 20, will raise the sub-surface temperature of the substrate to approximately 25° C. to 35° C. If necessary, to ensure that the groundwater is at the required temperature, a part of the extracted groundwater is fed directly via the conduit 58 back into the source zone 30 or via the thermostatic mixer 48 where it is mixed with heated groundwater discharged from the solar collectors 26 of the heater component 24 before being treated and re-injected into the source zone 30.

The heated groundwater water from the solar collectors 26 is then fed to the venturis 54 where air is entrained in the heated groundwater together with additional nutrients, if applicable. The heated, treated groundwater water is re-injected into the substrate 20 via the recharge trench at, or upgradient of, the source zone of the plume in the substrate 20.

The heated, treated groundwater, firstly, raises the sub-surface temperature of the substrate to a range of approximately 25° C. to 35° C. which is the optimal range where aerobic bio-degradation occurs. The oxygenated and nutrient-carrying groundwater further stimulates the microbes in the substrate to effect bio-degradation of the contaminants thereby enhancing bioremediation of the site 22.

At present, in the retail petroleum industry legacy sites are typically left to bioremediate themselves. A “legacy site” is a property which has elevated levels of contamination that will cost more than the worth of the property to remediate to an “as of right uses” under land zoning. As a result of these legacy sites being left to bioremediate themselves, many are left in a derelict state for long periods creating an eyesore and public nuisance. This may result in the issuance of regulatory clean-up notices requiring remediation on a regulator-enforced timeline with the resultant significant expense.

In addition, many operational service station sites are also allowed to remain in a contaminated state as long as any existing contamination is appropriately managed and there is no danger of imminent environmental harm occurring. While such an approach can be cost-effective while the site is being operated it can lead to unnecessary expenditure during periodic re-tanking works or at times when existing contamination impacts on the site.

It is therefore an advantage of the disclosure that a system 10 is provided which significantly reduces these and related problems. The system 10 provides a low cost, low-maintenance method for enhancing the natural bioremediation processes of petroleum hydrocarbons resulting in significantly decreased periods over which contaminated sites, both legacy sites and operational petroleum sites, are able to be remediated.

The use of low-energy power sources, in particular solar energy power sources, means that the rate of contaminant bioremediation is able to be significantly increased whilst occurring in a substantially carbon neutral manner. In addition, the system 10 obviates the need for high energy consumption extraction and treatment equipment whilst operating in an environmentally friendly manner.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A site remediation system for remediating a site, the system comprising:
a liquid recirculation mechanism powered by a low energy power source, the liquid recirculation mechanism comprising
a liquid extraction component for extracting liquid to be remediated from a substrate at the site; and
a heater component for heating the extracted liquid, in turn, to increase a subsurface temperature of the substrate upon re-injection of the heated liquid into the substrate; and
a bioremediation mechanism arranged downstream of the heater component of the liquid recirculation mechanism, the bioremediation mechanism comprising a liquid treatment unit for treating the heated liquid prior to re-injection of the liquid into the substrate to effect enhanced substrate bioremediation via bio-degradation of contaminants at the site.

2. The system of claim 1 in which the liquid recirculation mechanism is configured to extract contaminated liquid from, or downgradient of a fringe of, a plume and to re-inject the heated, treated liquid into, or upgradient of, a source zone of the plume.

3. The system of claim 1 in which the liquid extraction component comprises at least one extraction pump.

4. The system of claim 3 in which the at least one extraction pump is a solar powered pump.

5. The system of claim 1 in which the heater component comprises at least one solar collector.

6. The system of claim 5 in which the heater component comprises an array of solar collectors.

7. The system of claim 1 in which the heater component is configured to heat the liquid to a temperature in a range of about 20° C.-50° C.

8. The system of claim 8 in which the heater component is configured to heat the liquid to a temperature of between about 5° C.-15° C. greater than the subsurface temperature of the substrate.

9. The system of claim 1 in which the bioremediation mechanism comprises at least one entrainment device for at least one of oxygenating the liquid and entraining nutrients in the liquid prior to re-injection of the liquid into the substrate.

10. The system of claim 9 in which the at least one entrainment device comprises a venturi.

11. The system of claim 9 in which the entrainment device is configured to entrain both air to oxygenate the liquid and nutrients for enhancing bioremediation effected by subsurface microbes in the substrate.

12. The system of claim 1 which further comprises a filtration device arranged upstream of the bioremediation mechanism, the filtration device removing contaminants from the heated liquid prior to treating the liquid in the bioremediation mechanism.

13. The system of claim 2 which further comprises an infiltration gallery located within the source zone of the plume for distributing the re-injected treated liquid in the substrate.

14. The system of claim 1 which is mounted on a displacement mechanism for ease of placement at the site.

15. A method of remediating a site, the method including
extracting liquid to be remediated from a substrate at the site using a low energy power source;
heating the extracted liquid prior to re-injecting the liquid into the substrate to increase a subsurface temperature of the substrate upon re-injection of the heated liquid into the substrate; and
treating the heated liquid prior to re-injection of the liquid into the substrate to effect enhanced substrate bioremediation via bio-degradation of contaminants at the site.

16. The method of claim 15, which further comprises extracting liquid from, or downgradient of a fringe of, a plume and re-injecting the heated, treated liquid into, or upgradient of, a source zone of the plume.

17. The method of claim 15, which further comprises extracting the liquid using at least one extraction pump.

18. The method of claim 15, which further comprises heating the liquid using at least one solar collector.

19. The method of claim 18, which further comprises heating the liquid using an array of solar collectors.

20. The method of claims 15, which further comprises heating the liquid to a temperature in a range of about 20° C.-50° C.

21. The method of claim 20, which further comprises heating the liquid to a temperature of between about 5° C.-10° C. greater than the subsurface temperature of the substrate.

22. The method of claim 15, which further comprises treating the liquid prior to re-injection into the substrate by at least one of oxygenating the liquid and entraining nutrients in the liquid prior to re-injection of the liquid into the substrate.

23. The method of claim 22, which further comprises entraining material in the liquid using at least one venturi.

24. The method of claim 22, which further comprises entraining both air to oxygenate the liquid and nutrients for enhancing bioremediation effected by subsurface microbes in the substrate.

25. The method of claim 15, which further comprises filtering the heated liquid to remove contaminants prior to treating the liquid.

26. The method of claim 16, which further comprises distributing the re-injected, treated liquid in the substrate using an infiltration gallery or infiltration wells at, or upgradient of, the source zone of the plume.
